(19) United States
(12) Patent Application Publication
(10) Pub. No.: US 2007/0089569 A1
(43) Pub. Date: Apr. 26, 2007

(54) Opening device & Method of manufacture

(75) Inventor: Hector Ray Hernandez JR., Fullerton, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Alltrade Tools LLC

(21) Appl. No.: 11/255,841

(22) Filed: Oct. 20, 2005

(51) Int. Cl. B67B 7/44; B67B 7/14; B67B 7/18

(52) U.S. Cl. 81/3.09; 81/3.43

(57) ABSTRACT

An opening device comprises an elongated body having at a tail end two different types of openers and at a head end opposite the tail end a strap wrench. One type of opener is a pry-to-open opener and the other type of opener is a wrench opener. A handle with an anti-slip grip connects the head and tail ends.

### INCORPORATION BY REFERENCE

The inventor incorporates herein by reference any and all U.S. patents, U.S. patent applications, and other documents, hard copy or electronic, cited or referred to in this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

“Rectangular” includes square.

### BACKGROUND OF INVENTION

There are many types of devices used to connect and disconnect a pair of items attached to each other. There are pry-to-open openers that are used to detach, for example, a cap crimped to close an open mouth of a bottle. There are strap openers having a looped strap that is manually warped around, for example, a twist-to-open cap connected by threads to a container. The strap is tightened around the circumference of the cap and the strap opener is rotated to turn the cap until it is loosened or tightened on the container. There are wrench openers that fit snug over or around to grip and hold an item tightly, for example, a twist-to-open cap connected by threads to a container. While gripping the cap, the wrench opener is rotated to turn the cap until it is loosened or tightened on the container. Each type of opener is typically limited to one application, The pry-to-open openers are unsuited to detach items connected together by threads. Strap openers are poorly suited for attaching and detaching small diameter items, because the looped strap cannot properly grip a diameter of less than about 1.5 inches. A wrench opener may be used to open such small diameter items, but may only be used with a single or limited diameter range of items. Various types of openers are depicted in U.S. Pat. Nos. 2,330,893; 3,962,936; 4,008,636; 4,010,662; 4,145,938; 4,221,140; 4,25.7,288; 4,345,494; 4,455,894; 4,474,087; 4,506,568; 4,532,833; 4,543,858; 4,598,615; 4,607,407; 4,646,593; 4,723,465; 4,846,024; 4,750,389; 4,848,192; 4,916,993; 4,967,622; 4,979,407; 4,981,228; 4,987,804; 5,090,274; 5,115,700; 5,313,859; 5,333,522; 5,388,297; 6,101,903; 6,105,468; 6,196,090B1; 6,212,721B1; 6,282,985B1; 6,427,561B1; 6,490,951B1; 6,520,052B1; 6,789,450B1; 6,834,568B2; 6,918,150B1, and U.S. Design Pat. Nos. D297,203; D238,411.

### SUMMARY OF INVENTION

This invention has one or more features as discussed subsequently herein. After reading the following section entitled “DETAILED DESCRIPTION OF ONE EMBODIMENT OF THIS INVENTION,” one will understand how the features of this invention provide its benefits. The benefits of this invention include, but are not limited to: combing in a single device a pry-to-open opener, a strap wrench, and a wrench opener.

Without limiting the scope of this invention as expressed by the claims that follow, some, but not necessarily all, of its features are:

One, the opening device of this invention has an elongated body, which may be unitary, having at a first end two different types of openers: a first opener adapted to attach and detach items by rotation of one item with respect to the other item and a second opener adapted to detach items by lever action. The first opener may be a wrench opener and the second opener may be a pry-to-open opener. At a second end opposite the first end is a strap wrench. A handle member, which may include a grip, extends between the first and second ends. The grip may comprise an anti-slip material.

Two, the body may be molded from a plastic material and the handle member may have a recess therein that receives the anti-slip material forming the grip. The handle member may have a length substantially from 3.5 to 6 inches and a substantially oblong cross-sectional configuration having a length greater than its width. The handle portion is oriented with respect to the strap wrench and wrench opener so that, in use, a force applied to the handle portion rotates the strap wrench or wrench opener is in a direction substantially along the length. When the pry-to-open opener is being used, the handle portion is oriented so that a force applied to it to open a pry-to-open item is in a direction substantially along the width.

Three, a support element at the end including the two different types of openers may have a wall member with first and second opposed open ends and an internal surface. The wall member may be substantially continuous. The pry-to-open opener may be at the first end and the wrench opener may be at the second end opposite the pry-to-open opener. The internal surface may be in the form of a truncated cone with alternating ridges and grooves therein extending lengthwise between the open ends. The first open end may have a diameter greater than the diameter of the second open end. Using such a conical surface accommodates a number of items having a limited range of different diameters or widths. The plate element may be embedded in the support element nearby the second open end. The pry-to-open opener may include a metallic plate element with an aperture therein. This plate element may be inserted into a mold and embedded in the body during molding of the body member. Because the two different types of openers are opposed to each other, this enables a user to orient the device in one position for use of one type of opener and then invert the device for use of the other type of opener.

Four, a series of alternating substantially parallel grooves and ridges may be along an edge of the second end of the body. The strap wrench may include a pair of slots extending from this edge to one side of the body. Each slot may have one terminal opening in the edge and another terminal opening in the one side. A strap member is looped through the slots to provide an adjustable diameter adapted to be wrapped around items having varying diameter or width typically greater than about 1.5 inches, for example, having a diameter or width substantially from 1.5 to 10 inches. Thus an adjustable strap wrench is provided. A raised segment along the edge may be positioned so that the grooves and ridges are on one side of the raised segment and the terminal openings in the edge are on the other side of the raised segment.

These features are not listed in any rank order nor is this list intended to be exhaustive.

This invention also includes a method of manufacturing the opening device of this invention. The method comprises injection molding a plastic into the elongated unitary body member, including the steps of (a) forming in the body member a head end including slots for a strap of a strap wrench, a tail end including a continuous wall member with opposed open ends, and an intermediate handle portion between the tail and head ends,

(b) forming in the wall member an inward tapering internal surface in the form of a truncated cone with alternating ridges and grooves therein extending lengthwise between said open ends of the wall member, said first open end having a diameter greater than a diameter of the second open end.

(c) embedding in the wall member nearby the second open end a metallic plate element with an aperture having a prying lip, and

(d) forming a recess in the handle portion and filling the recess with an anti-slip material to provide a grip on the handle portion.

This method may be a two-stage process where in a first mold the recess is formed in the handle portion and subsequently in a second mold the recess is filled with the anti-slip material. Alternately, the method may be a single-stage process where in one mold the recess is formed in the handle portion and subsequently in the same mold a space adjacent the recess is filled with the anti-slip material.

### DESCRIPTION OF THE DRAWING

One embodiment of this invention, illustrating all its features, will now be discussed in detail. This embodiment depicts the novel and non-obvious opening device of this invention as shown in the accompanying drawing, which is for illustrative purposes only. This drawing includes the following figures (FIGS.), with like numerals indicating like parts:

FIG. 1 is a perspective view with the tail end of the opening device of this invention nearest the viewer.

FIG. 2 is a perspective view showing the side of the opening device opposite that shown in FIG. 1.

FIG. 3 is a perspective view with the head end of the opening device nearest the viewer.

FIG. 4 is a topside view taken along line 4-4 of FIG. 6.

FIG. 5 is a bottom side view taken along line 5-5 of FIG. 6.

FIG. 6 is a left hand side view of the opening device of this invention as seen in FIG. 1.

FIG. 7 is a cross-sectional view taken along line 7-7 of FIG. 4 with the grip removed.

FIG. 7A is a cross-sectional view taken along line 7A-7A of FIG. 7.

FIG. 8A is a side view of the opening device with the strap wrench having its strap wrapped around a twist-to-open item prior to rotating the opening device.

FIG. 8B is a side view similar to that of FIG. 8A with the opening device rotated.

FIG. 9 is a cross-sectional view taken along line 9-9 of FIG. 3.

FIG. 10 is a cross-sectional view showing a wrench opener of the opening device of this invention engaging a threaded cap attached to a bottle.

FIG. 11 is a cross-sectional view showing a pry-to-open opener detaching a crimped cap from a bottle top.

### DETAILED DESCRIPTION OF ONE EMBODIMENT OF THIS INVENTION

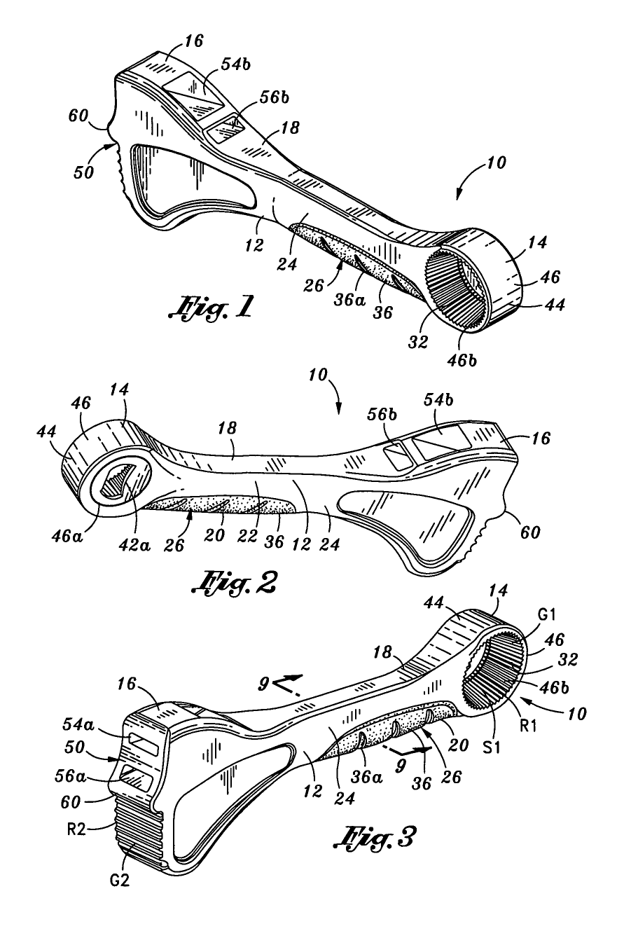

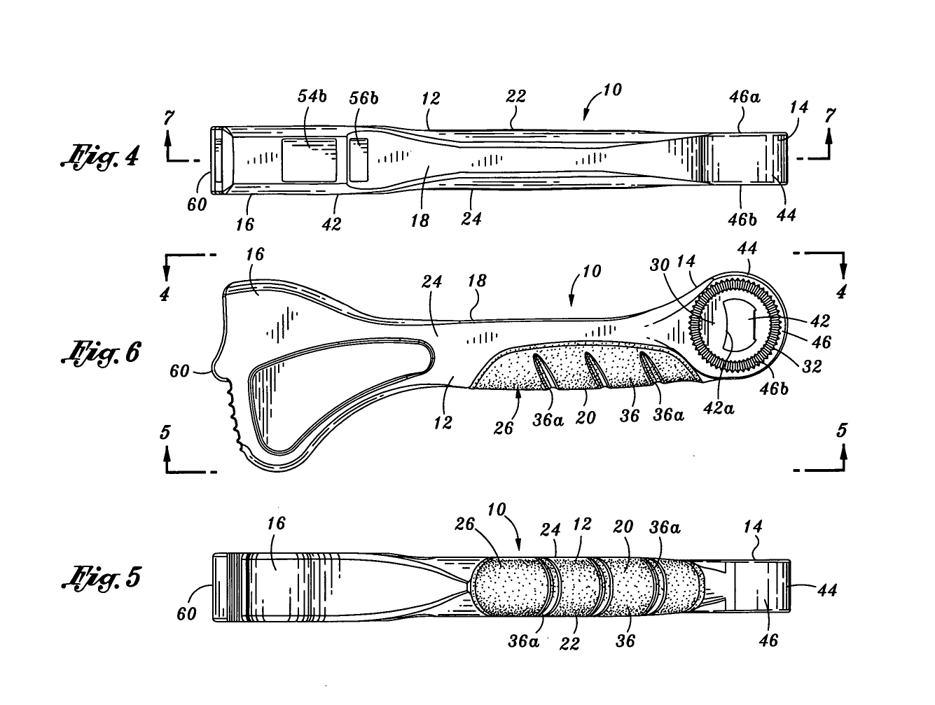

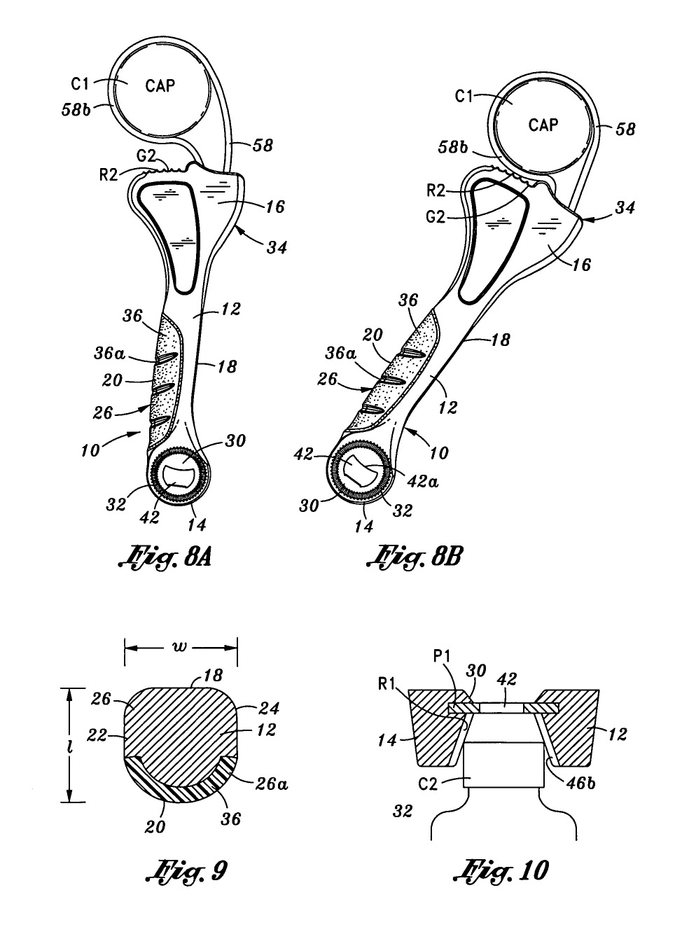

As illustrated in FIGS. 1 through 3, the opening device 10 of this invention includes an elongated unitary body member 12 molded from a plastic such as, for example, polypropylene. It has a tail end 14, a head end 16, a top side 18, a bottom side 20, a right hand side 22 when looking at the head end 16 as viewed in FIGS. 2 and 9, and a left hand side 24 as viewed in FIGS. 1, 6 and 9. An intermediate handle portion 26 extends between the tail end 14 and head end 16. This handle portion 26 has a length substantially from 3.5 to 6 inches, and as best shown in FIG. 9 has a generally oblong cross-sectional configuration with a long dimension of length l greater than its short dimension of width w.

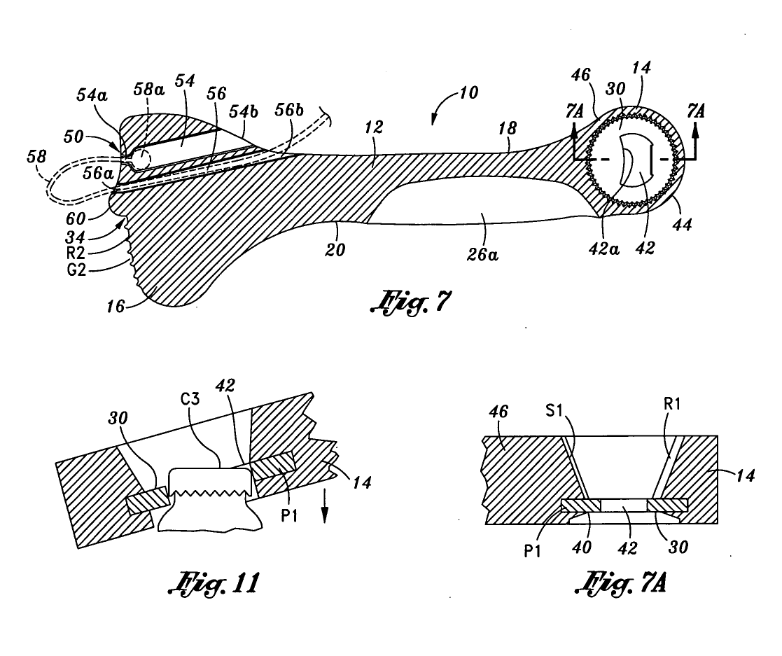

At the tail end 14 are two different types of openers: a pry-to-open opener 30 best shown in FIG. 7A, and a wrench opener 32 best shown in FIGS. 1, 3, and 6. At the head end 16 is a strap wrench 34 best shown FIGS. 8A and 8B. As depicted in FIGS. 7 and 9, the handle portion 26 has a recess 26a formed therein during molding of the body member 12. This recess 26a is filled with an anti-slip material bonded to the handle portion 26 to form a grip 36 with spaced apart indentations 36a therein that are slanted towards the head end 16. This anti-slip material is typically a rubber polymer. The recess 26a and grip 36 are on the bottom side 20, but may encompass the entire circumference of the handle portion 26 covering all sides 18, 20, 22, and 24.

A support element 44 at the tail end 14 includes both the pry-to-open opener 30 and the wrench opener 32. The support element 44, which may have an external cylindrical configuration, comprises a continuous wall member 46 having opposed open ends 46a and 46b, with the open end 46a along the right hand side 22 as best shown in FIG. 2 and the open end 46b along the left hand side 24 as best shown in FIG. 1. As illustrated in FIGS. 3 and 7A, the wall member 46 has an internal surface S1 in the form of a truncated cone with alternating converging ridges R1 and grooves G1 therein extending lengthwise between the open ends 46a and 46b. The truncated conical surface S1 with the ridges R1 and grooves G1 forms the wrench opener 32.

Each open end 46a and 46b has a substantially circular perimeter. In the embodiment illustrated, the open end 46b has a diameter greater than the diameter of the open end 46a. The pry-to-open opener 30 includes a circular metallic plate element 40 with an aperture 42 therein. The plate element 40 is inserted into a mold used to form the body member 14 prior to injecting plastic into the mold. As best shown in FIG. 7A, when the mold is filled with plastic, the perimeter P1 of the plate element 40 is embedded in the wall member 46 to cover at least partially the open end 46a. The aperture 42 is centrally position and provides a prying lip 42a for removal of a crimped cap C3 as depicted in FIG. 11. This lip 42a may be pointed or convex in shape.

The head end 16 includes a multi-curved edge 50 best shown in FIG. 3. This edge 50 extends between the top side 18 and bottom side 20 and includes a series of alternating substantially parallel ridges R2 and grooves G2 along this edge. As best shown in FIG. 7, a pair of slots 54 and 56 each having a rectangular cross-section extend from the edge 50 through the body member 12 to an intermediate portion of the top side 18. Each slot 54 and 56 has respectively rectangular terminal openings 54a and 56a in the edge 50 and rectangular terminal openings 54b and 56b along the top side 18.

As best shown in FIGS. 7, 8A and 8B, a substantially flat strap member 58 (shown in dotted lines in FIG. 7) having a rectangular gross-section with a with substantially equal to the width of the slots 54 and 56 is looped through the slots. An enlarged end 58a of the strap member 58 is lodged in the slot 54. There is a raised segment 60 along the edge 50, and the ridges R2 and grooves G2 are on one side of this raised segment 60 and the terminal openings 54a and 56a are on the other side of this raised segment. The grip 36 is below the terminal openings 54b and 56b in the top side 18 of the body member 12. As illustrated in FIGS. 8A and 8B, with the strap 58 wrapped around the circumference of a cap C1, the user grasps the handle portion 26 and rotates the opening device 10 to twist the cap either open or closed as the user desires. Rotation causes an exterior segment 58b of the strap 58 to engage the series of ridges R2 and grooves G2 along the edge 50, tightening the strap around the cap C1.

As illustrated in FIG. 10, a bottle cap C2 is inserted into the open end 46b of the wrench opener 32. The ridges R1 and grooves G1 in the truncated conical surface S1 grip an edge of the cap C2, holding it firmly as the user turns the cap opening device 10 by applying a force in a direction along the length l of the oblong cross-section dimension. As illustrated in FIG. 11, the pry-to-open opener 30 is positioned with respect to the cap C3 to function as a lever. The cap C3 is inserted into the aperture 42 with the prying lip 42a engaging a crimped rim of the cap. As the user applies a downward force in a direction along the width w of the oblong cross-section dimension, the cap C3 is lifted off the bottle. Because the wrench opener 32 and the pry-to-open opener 30 are opposed to each other, this enables a user to orient the opening device 10 in one position for use of wrench opener 32 as shown in FIG. 10 and then invert the device for use of the pry-to-open opener 30 as shown in FIG. 11.

The body member 14 is manufactured by injection molding. The grip is formed either by a two-stage process or a single stage process. In the two stage process, a first mold is employed that forms the body member 14 described above, including at the head end 16 the slots 54 and 56 for the strap 58 and at the tail end 14 the hollow wall member 46, and an intermediate handle portion 26 between the tail end 14 and head end 16. The metallic plate element 40 is inserted into the first mold so that its perimeter P1 is embedded in the wall member 46 nearby the open end 46a as the plastic is injected into this first mold. The recess 26a in the handle portion 26 is formed by the internal shape of the first mold. The body member 14 with the plate element 40 and recess 26a therein is removed from the first mold and then placed in a second mold. This second mold has a wall adjacent the recess 26a and offset from the recess to provide an empty space corresponding to the configuration and volume of the grip 36. This space is then filled with the anti-slip material to form and bond the grip 36 of the handle portion 26. The single stage process uses only one mold and the body member 12 is not removed from this one mold. In the single stage process a removable plug having a shape corresponding to the configuration and volume of the grip 36 is located within the mold. After formation of the body member the plug is removed to provide a space corresponding to the configuration and volume of the grip 36. This space is then filled with the anti-slip material.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiment disclosed. On the contrary, the intention is to cover all modifications and alternate constructions coming within the spirit and scope of the invention as generally expressed by the following claims, which particularly point out and distinctly claim the subject matter of the invention:

1. An opening device comprising an elongated body having at a first end a first opener adapted to attach and detach items connected by threads and a second opener adapted to detach items connected by crimping one item to another item and at a second end opposite the first end a strap wrench.

2. The opening device of claim 1 where between the first and second ends is a handle member.

3. The opening device of claim 2 where the handle includes a grip comprising an anti-slip material.

4. The opening device of claim 3 where the body comprises a plastic material and the handle member has a recess therein that receives anti-slip material forming the grip.

5. An opening device comprising
an elongated, molded plastic, unitary body member having a first end and a second end and an intermediate handle portion between the first and second ends,
at the first end at least two different types of openers and at the second end a strap wrench, and
grip member comprising an anti-slip material bonded to the handle portion.

6. The opening device of claim 5 where the handle portion has a length substantially from 3.5 to 6 inches.

7. The opening device of claim 5 where the handle portion has a substantially oblong cross-sectional configuration.

8. The opening device of claim 5 where the two different types of openers are opposed to each other to enable a user to orient the device in one position for use of one opener and then invert the device for use of the other opener.

9. The opening device of claim 5 where one of the two different types of openers is a metallic, plate element with an aperture therein, said plate element being inserted molded in the body member.

10. The opening device of claim 5 where one of the two different types of openers comprises a truncated conical wall element having an internal surface with alternating ridges and grooves extending lengthwise between opposed open ends of the wall element.

11. An opening device comprising
an elongated, molded plastic, unitary body member having a head end including a strap wrench adapted to rotated a twist-to-open item and a tail end including a wrench opener adapted to rotated a twist-to-open item and a second type of opener adapted to open a pry-to-open item, and an intermediate handle portion between the head and tail ends,
a grip member comprising an anti-slip material bonded to the intermediate handle portion, and
at the tail end a support element comprising a continuous wall member forming the wrench opener, said wall member having first and second opposed open ends, and
a metallic plate element with an aperture therein forming the second type of opener, said plate element being embedded in the support element nearby the second open end.

12. The opening device of claim 11 where the wall member includes an internal surface in the form of a truncated cone with alternating ridges and grooves therein extending lengthwise between said open ends and said first open end has a diameter greater than the diameter of the second open end.

12. The opening device of claim 11 where the handle portion has a length substantially from 3.5 to 6 inches and a substantially oblong cross-sectional configuration having a length greater than its width, said handle portion being oriented with respect to the strap wrench and wrench opener so that a force applied to the handle portion to rotate the strap wrench or wrench opener is in a direction substantially along the length and being oriented with respect to the a pry-to-open opener so that a force applied to the handle portion to open a pry-to-open item is substantially along the width.

13. An opening device comprising
an elongated, molded plastic, unitary body member having a tail end, a head end opposite the tail end, and a top side and bottom side, said head end having an edge extending between the top side and bottom side,
a series of alternating substantially parallel grooves and ridges along the edge of the head end,
a pair of slots extending from the edge to the top side, each slot having one terminal opening in the edge and another terminal opening in said top side,
a strap member looped through the slots to provide an adjustable strap wrench,
a raised segment along the edge, said grooves and ridges being on one side of the raised segment and the terminal openings in the edge being on the other side of the raised segment, and
at the tail end a wrench opener including an internal wall member extending between opposed open ends of the wrench opener,
one open end being partially covered by a metallic member having an aperture therein with a prying lip to provide a prying element for removal of a crimped cap and
the other open end being uncovered and open to receive therein an item to be rotated, and
an intermediate handle portion between the tail and head ends having a grip member comprising an anti-slip material bonded to the body member, said grip member being along at least one said side and below the terminal openings in said top side of the body member.

14. The cap opening device of claim 13 including a right hand side and a left hand side opposed and between the top side and the bottom side, said open uncovered end being along the right hand side or the left hand side with the metallic member being embedded in the opposite right or left hand side.

15. An opening device comprising
an elongated, molded plastic, unitary body member having a first end and a second end and an intermediate handle portion between the first and second ends,
at the first end at least one type of opener and at the second end a strap wrench, and
grip member comprising an anti-slip material bonded to the handle portion.

16. A method of manufacturing an opening device, comprising injection molding from a plastic an elongated unitary body member including the steps of
(a) forming in the body member a head end including slots for a strap of a strap wrench, a tail end including a continuous wall member with opposed open ends, and an intermediate handle portion between the tail and head ends,
(b) forming in the wall member an inward tapering internal surface in the form of a truncated cone with alternating ridges and grooves therein extending lengthwise between said open ends of the wall member, said first open end having a diameter greater than a diameter of the second open end.
(c) embedding in the wall member nearby the second open end a metallic plate element with an aperture having a prying lip, and
(d) forming a recess in the handle portion and filling said recess with an anti-slip material to provide a grip on the handle portion.

17. The method of claim 16 comprising a two-stage process where
in a first mold the recess is formed in the handle portion and
subsequently in a second mold the recess is filled with the anti-slip material.

18. The method of claim 16 comprising a single-stage process where
in one mold forming the recess in the handle portion and
subsequently in the same mold filling a space adjacent the recess with the anti-slip material.
